(19) United States
(12) Patent Application Publication
(10) Pub. No.: US 2013/0226581 A1
(43) Pub. Date: Aug. 29, 2013

(54) COMMUNICATION DEVICE AND METHOD

(71) Applicants: HONG FU JIN PRECISION INDUSTRY (Shenzhen, (US); HON HAI PRECISION INDUSTRY CO., LTD., (US)

(72) Inventors: ZHEN-XING MA, Shenzhen City (CN); ZHENG-HENG SUN, Tu-Cheng (TW)

(73) Assignees: HON HAI PRECISION INDUSTRY CO., LTD., Tu-Cheng (TW); HONG FU JIN PRECISION INDUSTRY (Shenzhen) CO., LTD ., ShenZhen City (CN)

(21) Appl. No.: 13/626,902

(22) Filed: Sep. 26, 2012

(30) Foreign Application Priority Data
Feb. 29, 2012 (CN) 201210049293.3

(51) Int. Cl. G10L 15/00

(52) U.S. Cl. 704/246; 704/E15.039

(57) ABSTRACT

A communication method includes: capturing analog sound signals output by the audio output unit, and analyze the captured analog sound signals to obtain a corresponding digital audio information. Comparing the obtained digital audio information with a digital feature information stored in a storage unit to determine whether the obtained digital audio information includes the stored digital feature information. Playing a reply information stored in the storage unit if the obtained digital audio information includes the stored digital feature information.

### BACKGROUND

1. Technical Field

The present disclosure relates to electronic devices, and particularly to a communication device and method.

2. Description of Related Art

In telephone conferences, participants must remain on the line for a period of time. Sometimes, one participant may be away from the phone for a while during the telephone conference, and thus becomes unreachable during that time.

A communication device and method, to overcome the described limitations is thus needed.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure.

Moreover, in the drawings, like reference numerals designate corresponding parts throughout the several views.

FIG. 1 is a schematic diagram of a communication device, in accordance with an exemplary embodiment.

FIG. 2 is a block diagram of an electronic device, in accordance with an exemplary embodiment.

FIG. 3 is flowchart illustrating a communication method, applied in an electronic device, such as that of FIG. 1, in accordance with an exemplary embodiment.

### DETAILED DESCRIPTION

Embodiments of the present disclosure will be described with reference to the accompanying drawings.

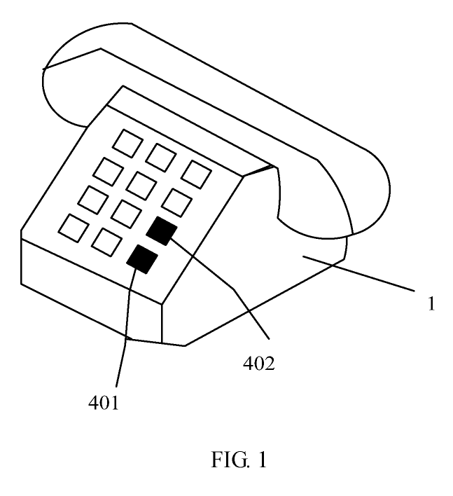

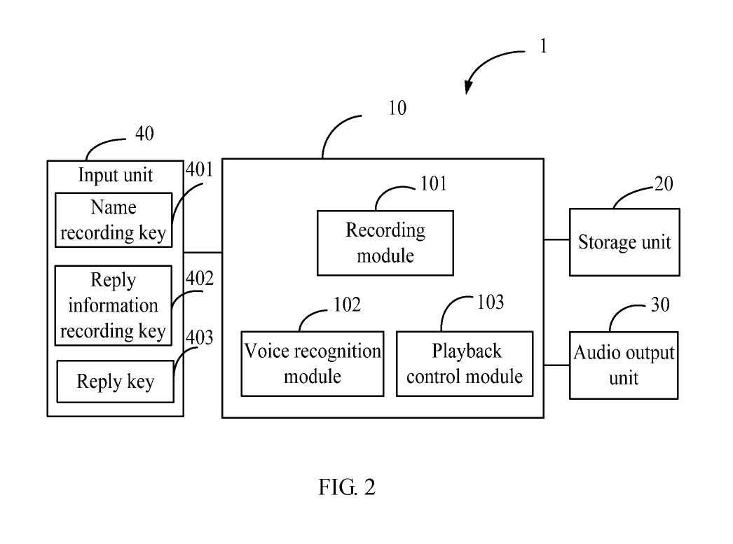

FIGS. 1 and 2 illustrate a communication device 1 including a processing unit 10, a storage unit 20, and an audio output unit 30.

The storage unit 20 stores a reply information. In the embodiment, the reply information includes where the user has gone, when the user would be back, for example. The audio output unit 30 is used to output sound of a person communicated via the communication device 1.

The processing unit 10 includes a recording module 101, a voice recognition module 102, and a playback control module 103.

The recording module 101 is used to obtain analog sound signal input by a user and convert the obtained analog sound signal to a digital feature information, and store the digital feature information into the storage unit 20, in response to user's operation. In the embodiment, the digital feature information includes data of the name of the user.

The voice recognition module 102 is used to capture analog sound signals output by the audio output unit 30, and analyze the captured analog sound signals to obtain a corresponding digital audio information. The voice recognition module 102 is also used to compare the obtained digital audio information with the digital feature information stored in the storage unit 20 to determine whether the obtained digital audio information includes the digital feature information.

When the voice recognition module 102 determines the obtained digital audio information includes the stored digital feature information, the playback control module 103 plays the reply information stored in the storage unit 20.

When the user is taking part in a telephone conference via the communication device 1, if the user leaves for a period and there is a person calling the name of the user, the audio output unit 30 will output the analog sound signals including the name of the user. The voice recognition module 102 analyzes the captured analog sound signals to obtain the corresponding digital audio information, and determines the obtained digital audio information includes the digital feature information, for example, the name of the user, stored in the storage unit 20. Then the playback control module 103 plays the reply information stored in the storage unit 20 to reply to the person automatically.

In the embodiment, the electronic device 1 also includes an input unit 40. The input unit 40 includes a name recording key 401, a reply information recording key 402, and a reply key 403. The recording module 101 obtains the analog sound signals input by a user and converts the obtained analog sound signals to the corresponding digital audio information, and store the digital audio information into the storage unit 20, when the name recording key 401 is operated. The recording module 101 obtains analog sound signals input by a user and converts the obtained analog sound signals to the corresponding reply information, and stores the recorded reply information into the storage unit 20, when the reply information recording key 401 is operated. The reply information is previous stored in the storage unit 20.

The voice recognition module 102 and the playback control module 103 respectively execute the functions described above only when the reply key 403 is operated. For example, when the user leaves for a period of time, the user can operate the reply key 403, and then voice recognition module 102 and the playback control module 103 would execute the corresponding functions and then automatically reply to the person who is calling the user.

In the embodiment, the communication device 1 can be a mobile phone, a wire phone, and etc. The audio output unit 30 can be a speaker, an earphone, and etc.

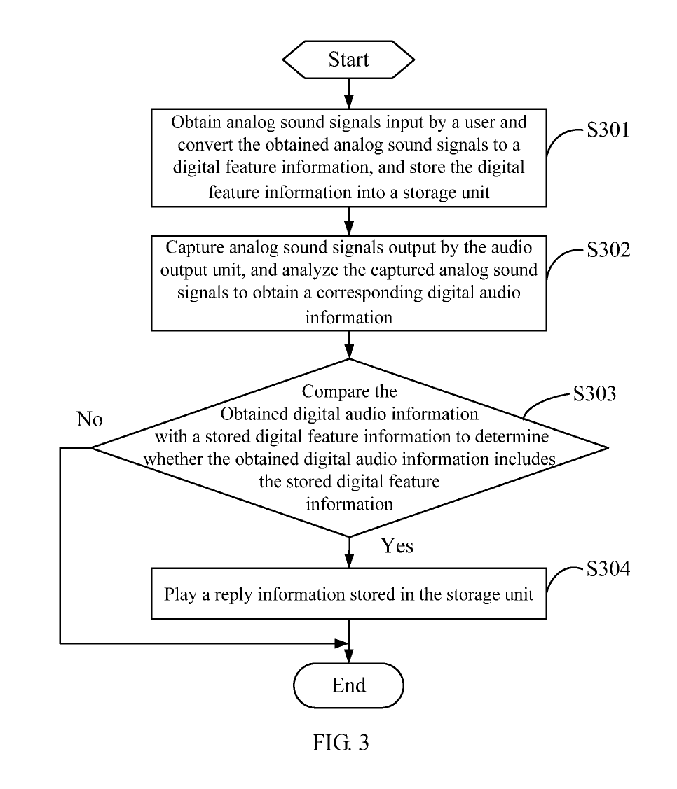

Referring to FIG. 3, a flowchart illustrating a communication method is shown.

The method is applied in the electronic device 1 as shown in FIG. 1. In step S301, the recording module 101 obtains analog sound signals input by the user and converts the obtained analog sound signals to a corresponding digital feature information, and stores the digital feature information into the storage unit 20, in response to user's operation.

In step S302, the voice recognition module 102 captures analog sound signals output by the audio output unit 30, and analyzes the captured analog sound signals to obtain a corresponding digital audio information.

In step S303, the voice recognition module 102 compares the obtained digital audio information with the digital feature information stored in the storage unit 20 to determine whether the obtained digital audio information includes the stored digital feature information.

If the voice recognition module 102 determines the obtained digital audio information does not include the stored digital feature information, the procedure ends. Otherwise, in step S304, the playback control module 103 plays the reply information stored in the storage unit 20.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A communication device comprising:
a storage unit storing reply information;
an audio output unit, configured to output analog sound signals when the communication device is communicated with another communication devices; and
a processing unit comprising:
a voice recognition module, configured to capture the analog sound signals output by the audio output unit, and analyze the captured analog sound signals to obtain a corresponding digital audio information; and further configured to determine whether the obtained digital audio information comprises a digital feature information; and
a playback control module, configured to play the reply information stored in the storage unit when the voice recognition module determines the obtained digital audio information comprises the digital feature information.

2. The communication device according to claim 1, wherein the processing unit further comprises a recording module, the recording module is configured to obtain analog sound signals input by a user and convert the obtained analog sound signals to the digital feature information, and store the digital feature information into the storage unit, in response to user's operation.

3. The communication device according to claim 2, further comprising a name recording key, the recording module obtains the analog sound signals input by a user and converts the obtained analog sound signals to the digital feature information, and store the digital feature information into the storage unit, only when the name recording key is operated.

4. The communication device according to claim 2, wherein the digital feature information comprises data of the name of the user.

5. The communication device according to claim 1, further comprising a reply information recording key, the recording module obtains analog sound signals input by a user and converts the obtained analog sound signals to the reply information, and stores the recorded reply information into the storage unit, when the reply information recording key is operated.

6. The communication device according to claim 1, further comprising a reply key, the voice recognition module and the playback control module respectively execute the functions only when the reply key is operated.

7. The communication device according to claim 1, wherein the communication device is a mobile phone or a wire phone.

8. The communication device according to claim 1, wherein the audio output unit is a speaker or an earphone.

9. A communication method, applied in a communication device, wherein, the communication device comprises:
a storage unit storing reply information and a digital feature information; and
an audio output unit, configured to output analog sound signals when the communication device is communicated with another communication devices;
the method comprising:
capturing the analog sound signals output by the audio output unit, and analyze the captured analog sound signals to obtain a corresponding digital audio information;
comparing the obtained digital audio information with the digital feature information stored in the storage unit to determine whether the obtained digital audio information comprises the stored digital feature information;
playing the reply information stored in the storage unit if the obtained digital audio information comprises the stored digital feature information.

10. The method according to claim 9, further comprising:
obtaining analog sound signals input by a user and convert the obtained analog sound signals to the digital feature information, and store the digital feature information into a storage unit, in response to user's operation.

11. The method according to claim 9, further comprising:
obtaining analog sound signals input by the user and convert the obtained analog sound signals to the reply information, and storing the reply information into the storage unit, in response to user's operation.
